(19) United States
(12) Patent Application Publication
(10) Pub. No.: US 2003/0040885 A1
(43) Pub. Date: Feb. 27, 2003

(54) Apparatus and method for determining vehicle load weight status

(76) Inventors: Jeffrey N. Schoess, Buffalo, MN (US); Douglas P. Mortenson, Maple Grove, MN (US); Thomas R. Jicha, Elk River, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/929,170

(22) Filed: Aug. 14, 2001

(51) Int. Cl. G06F 15/02

(52) U.S. Cl. 702/173

(57) ABSTRACT

A system and method for determining load weight status for a vehicle, such as a rail car, is provided. The system may include an acceleration sensor secured to the vehicle, and a processor. The acceleration sensor is operable to obtain a vibration input associated with the vehicle, and the processor is operable to determine the load weight status from the vibration input using time domain processing. The time domain processing may include performing a histogram analysis on the vibration input, applying a selective threshold detection scheme, and performing a multi-timeslot voting procedure, according to one embodiment.

### FIELD OF THE INVENTION

Embodiments disclosed herein relate to an apparatus and method for determining load weight status of a vehicle, such as a cargo vessel, rail car, or other similar transport equipment.

### BACKGROUND OF THE INVENTION

Cargo vessels and rail cars are commonly used to transport items from place to place. Operators of such vehicles need to be aware of the state of the vehicle. For example, whether a vehicle is full or empty affects the manner in which the vehicle is controlled. An operator can control the vehicle by adjusting the force required to brake the vehicle safely and without damage. If too little force is used, insufficient control of the vehicle can occur, resulting in, for example, increased stopping distance. Conversely, if too much force is used, the braking system can be excessively worn or damaged.

To provide this needed information to operators, various load weight sensors have been developed. For example, the freight rail industry has employed pneumatically operated mechanical load weight sensors. Such sensors, however, have accuracy and alignment limitations.

In addition, numerous electronic load sensors have been developed, including rotary Hall sensors, load cell sensors, optical displacement sensors, proximity displacement sensors (RF-based), ultrasonic sensors, and capacitive sensors. Each of these sensors suffers from one or more disadvantages. One disadvantage common to all these sensors relates to the location that the sensors must be mounted. For example, in the freight rail environment, these sensors must be mounted at the cargo vessel truck level, between the wheels and the cargo box, in order to sense and measure the displacement between the cargo box and the rail truck, which decreases as load is applied. Positioning a sensor at such a location exposes the sensor to debris and dirt, and subjects the sensor assembly to ice build-up in cold environments. These environmental factors can adversely affect sensor accuracy.

Thus, there is a need for an apparatus and method for detecting vehicle load weight status that reduces or eliminates the need for frequent alignment and calibration while still providing accurate load weight status.

There is also a need for an apparatus for detecting vehicle load weight status that can be mounted in a location with reduced exposure to environmental factors, such as debris, dirt, and ice build-up.

### BRIEF DESCRIPTION OF THE DRAWINGS

FIG. 1a is a simplified block diagram illustrating a model of a rail car in motion.

FIG. 2 is a functional perspective block diagram illustrating one exemplary embodiment of the present invention.

FIGS. 3A-3C are functional block diagrams illustrating three more exemplary embodiments of the present invention.

FIG. 4 is a simplified block/schematic diagram of a load sensing apparatus according to an embodiment of the present invention.

FIG. 5 is a simplified pictorial/block diagram illustrating a preferred embodiment of the present invention.

FIGS. 6A-6D are frequency response diagrams for a loaded rail car and an unloaded rail car at relatively low and high speeds, respectively.

FIG. 7 is a flow diagram illustrating a method for determining load weight status according to a preferred embodiment of the present invention.

FIGS. 8A and 8B are graphical diagrams illustrating 3-D profiles and 2-D time slices for a loaded car and an unloaded car, respectively.

### DETAILED DESCRIPTION

Load Weight Sensing Apparatus Configurations

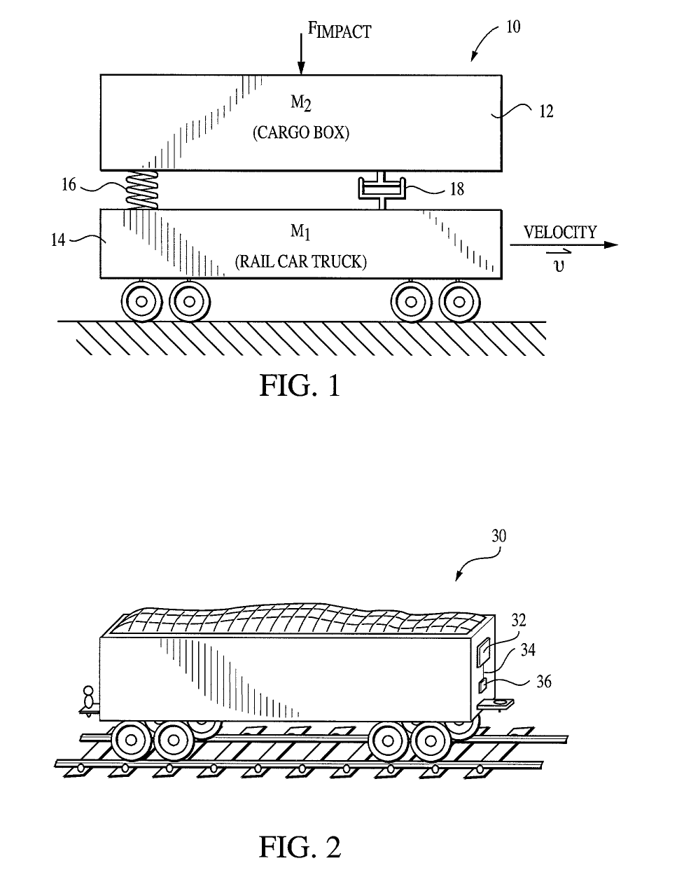

Various embodiments described herein may make assumptions based on a model similar to that shown in FIG. 1. FIG. 1 illustrates a rail car 10 in motion, with a cargo box 12 associated with a rail car truck 14. The dynamic (frequency) response can be summarized by a combination of a mass M2, spring 16, and damper 18, having an associated resonant frequency. An applied impact force function F_{impact} is likely to result in one or more resonant damped vibrations for the cargo box 12 as it is moving. Exemplary impact force sources include rail wheel hop, wheel faults (i.e. a flat wheel or wheel shelling or wear), and rail track discontinuities. The actual weight of the cargo box 12 and its contents can be accurately determined by measuring the resonant frequency response signature, and comparing that signature with predetermined data from varying cargo weight conditions (e.g. empty and full). The predetermined data may, for example, be collected using a data logger and post-processing techniques. This technique may also apply to non-rail car settings, as well.

While an accurate determination of load weight status may be made in the frequency domain, such a solution may be undesirable for several reasons. First, the techniques required for deployment in the frequency domain may be too computationally intensive for many real-world applications. Complicated algorithms and Fourier transforms are likely to be involved in a frequency domain solution. This processing is likely to require relatively expensive circuitry. This may be problematic for applications in which many such load weight sensor installations are required. For example, in a rail car setting, it may desirable for every rail car to be equipped with a load weight sensing apparatus. If each sensing apparatus is relatively expensive, the cost associated with equipping an entire fleet of rail cars may be prohibitively expensive.

Similarily, because Fast Fourier Transform (FFT) computations typically require more computational resources than a time domain technique, such as the time domain histogram processing technique disclosed herein, electrical power dissipation may become an issue. The additional CPU operations associated with processing and calculating frequency domain results likely leads to higher power dissipation, and may require additional electrical power resources, such as higher battery capacities. Thus, preferred embodiments of the present invention make determinations of load weight status in the time domain, rather than in the frequency domain, as described below. An indication of the resonance frequency signature may be realized from a vibration signature, such as one obtained with a single-axis weight (acceleration) sensor and an associated processor, such as a microcontroller. There should also be an output mechanism, to provide the load weight status to a user or monitoring system. The vibration signature enables time-domain determination of load weight status. According to one embodiment of the present invention, an acceleration sensor is provided in combination with a processor. FIG. 2 illustrates a functional perspective block diagram of an exemplary embodiment, in which the load weight status of a rail car 30 is to be determined. An acceleration sensor 32, such as a dedicated single axis accelerometer sensor, is mounted to the rail car 30, and provides a vibration input (e.g. 1 volt per unit of acceleration (g's)) via a link 34 to a processor 36, such as a microcontroller. An example of such a processor is the 8-bit H8 processor, available from Hitachi. The processor 36 provides load weight processing support, and may provide support for other functions, such as hand brake control and communication. In addition, other status information, such as information pertaining to the rail car's physical condition, could be obtained with the H8 processor, by identifying determinative characteristics of the time response. Load weight processing is preferably performed in the time domain, using techniques described in further detail below. Such techniques may be implemented as software, firmware, or hardware, for example.

The load weight processing may be used to determine a load weight status for the rail car 30. The determined load weight status may be a binary determination, such as empty versus full, or it may be more quantitative in nature, such as an indication of actual weight. The load weight status may then be communicated to the appropriate user or system, using one of a number of possible schemes. For example, the load weight status may be communicated via a wireless link to a handheld terminal carried by a railyard support technician. The result may also be communicated via a hard-wired connection to another location on the vehicle, such as to a locomotive pulling the rail car 30. In an alternative embodiment, the acceleration data obtained from the acceleration sensor 32 is transmitted across a wireless or hard-wired link to a processor at another location. For example, acceleration data may be transmitted to a handheld terminal or traffic control tower, for subsequent processing to determine a load weight status. Other output schemes may also be utilized. In another alternative embodiment, the acceleration sensor 32 and processor 36 are composed within a single unit, obviating the need for the external link 34. Single chip or multiple chip implementations may be used to provide the load weight sensing system illustrated in FIG. 2, as may other implementations.

It should be noted that FIG. 2 is merely an exemplary setup, and other configurations may also be used. For example, the acceleration sensor 32, the link 34, and/or the processor 36 may be placed at another location on the rail car 30. It may be desirable to have one or more of these components enclosed within a portion of the rail car 30 to avoid exposure to outside elements. For many applications, mounting on the outside of the car is preferred to avoid interfering with cargo being transported in the cargo box. When outside mounting is used, the acceleration sensor 32, link 34, and/or processor 36 are preferably mounted relatively high on the rail car, away from the rail car truck carrying the wheels. This will avoid problems with debris, dirt, and ice build-up.

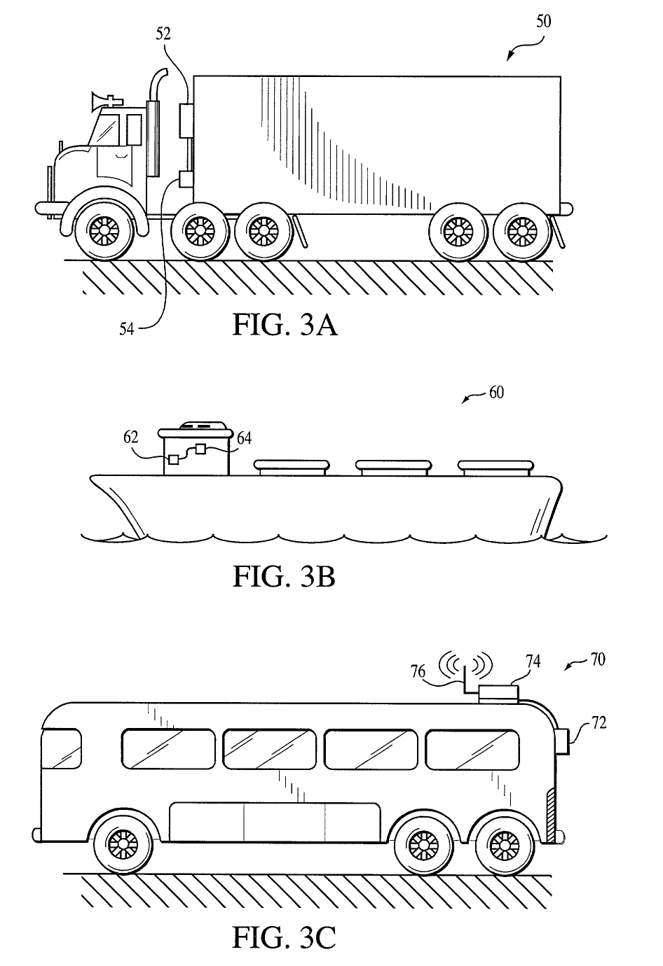

Additionally, although FIG. 2 shows a rail car 30 to demonstrate embodiments of the present invention, other applications are also intended to be included within the scope of the present invention. FIGS. 3A, 3B, and 3C illustrate other load weight sensing applications that may be realized using various embodiments of the present invention. FIG. 3A illustrates a truck 50, with an acceleration sensor 52 and a processor 54. FIG. 3B illustrates a boat 60, with an acceleration sensor 62 and a processor 64. FIG. 3C illustrates a bus 3C, with an acceleration sensor 72, a processor 74, and a wireless transceiver 76 for wireless communication of load weight status to a fleet administration authority. Other applications involving moving equipment or vehicles are also suitable candidates for applying embodiments of the present invention. In FIGS. 2, 3A, 3B, and 3C, the acceleration sensors and processors are shown as being relatively large in size as compared to the associated vehicle. This is for convenience only, and actual implementations are likely to be much smaller. Many acceleration sensors are smaller in area than a square centimeter. Processors are likewise often miniature in size.

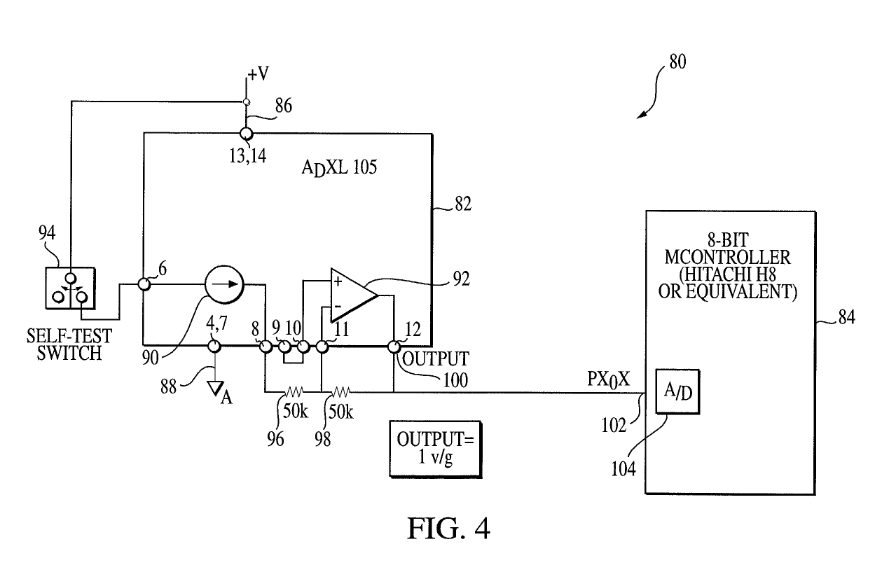

FIG. 4 is a block diagram illustrating a load sensing apparatus 80 for determining load weight status according to a preferred embodiment of the present invention. The load sensing apparatus 80 includes an acceleration sensor 82 and a processor 84.

In the embodiment shown in FIG. 4, the acceleration sensor is a +/−5 g ADXL accelerometer, part no. AXDL 105, offered by Analog Devices, Inc. of Norwood, Mass. This sensor functions to convert mechanical vibrations into electrical signals. The connections are likely to be dictated by the specific acceleration sensor chosen. The acceleration sensor 82 is connected between a voltage source 86 and ground 88, to provide a current source 90, and electrical power for an amplifier 92. A self-test switch 94 may also be included within this embodiment. Resistors 96 and 98 are selected according to sensor specifications or requirements in order to provide the desired output characteristics at output 100. In a preferred embodiment, the output is provided at one volt per unit of acceleration (g). The acceleration sensor 82 may have additional or alternative features other than what is shown in FIG. 4.

The output from the acceleration sensor 82 is provided to an input 102 of the processor 84. The processor 84 is preferably the Hitachi H8 eight-bit microcontroller. This input is connected directly or indirectly to an analog-to-digital (AID) converter 104. Once the analog acceleration data is converted to digital data, time-domain processing may begin, using variations of algorithms and/or techniques described in detail below. The processor 84 is also likely to contain other features besides what is shown in FIG. 4. For example, the processor 84 may include internal or external memory (random access or read-only) to store programs and/or to enable calculations and temporary storage of results.

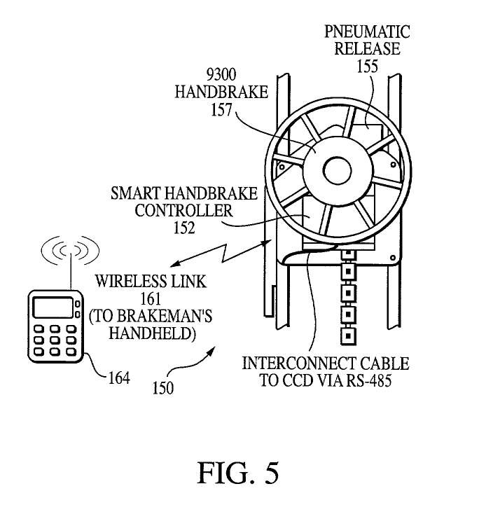

According to a preferred embodiment of the present invention, the load sensing apparatus is utilized with a rail car and is integrated into a rail car handbrake device 150, as shown in FIG. 5. The handbrake device 150 includes a handbrake controller 152 having a microprocessor and a pneumatic brake release mechanism 155 for the handbrake 157. One such commercially available product is the Handbrake Sensor and Release Monitor (HSRM), product no. HG3100BA, available from Honeywell International Inc. of Morristown, N.J., the assignee of the present invention. In such an embodiment, the acceleration sensor provides acceleration (vibration) data directly to the microprocessor of the controller 152. In a further embodiment, information about the load weight status is communicated via a wireless link 161 to an operator's handheld data terminal 164. Alternatively, the data could be communicated to a fixed track-side terminal (not shown).

In the embodiment of FIG. 5, load weight status algorithms are processed using the Smart Handbrake system processor. Alternately, the algorithm could be processed in a dedicated electric brake controller or a locomotive cab processor. Commonly-assigned U.S. Pat. No. 6,175,784 B1, “Remotely Operated Rail Car Status Monitor and Control System,” naming Thomas Jicha and Randy Lokken as inventors, describes a handheld data terminal and other devices that may be utilized with or included within the embodiments described herein. U.S. Pat. No. 6,175,784 B1 is incorporated by reference herein, in its entirety. Of course, any other processing means may also be utilized.

Determination of Load Weight Status from Acceleration (Vibration) Data

The dynamic motion of a moving cargo vessel creates inertial mass forces. In general, the dynamic response of vehicles in motion can be summarized by a combination of a mass, spring, and damper (see FIG. 1) that has an associated resonant frequency and an input function value (“IFV”). The combination of the masses, springs, and dampers within the cargo vessel result in many resonant frequencies, along with the superposition of their IFVs. Several IFVs exist for a particular cargo vessel and act like “impact” sources. Examples of IFVs for a rail car include rail wheel hop, wheel faults (such as flat wheel or wheel shelling or wear), and rail track discontinuities.

Since a cargo vessel, such as a rail car, is a dynamically active structure, it can be modeled as a transfer function with multiple inputs and outputs. Each input value, such as a vibration stimulus from a railcar wheel-set due to wheel failure or damage, excites the railcar structure in a different way, thereby creating a structural mode shape. The structural response may also be affected by structural integrity effects (i.e., damage to the railcar structure), changes in railcar suspension performance (i.e., stiffness factor, overloading), or environmental factors. Each structural vibration pattern (i.e., mode) that is created has a unique shape and mode-dampening factor when represented in the frequency domain. The shape of the mode indicates its resonant frequency and possibly identifies existing structural damage or suspension system damage. The shape further indicates the structural stiffness properties for the dampening factor. Thus, the vibration mode shape and the mode-dampening factor as a function of frequency provide additional ancillary data related to the detection of vehicle safety conditions such as wheel performance, bearing failure, and brake shoe wear, and quality assessment data for identification and prevention of cargo freight damage. For example, wheel failure, bearing failure, and brake shoe wear may result in a dampening and/or shifting of the resonant frequency.

In addition, shifting of mass in the rail car (or other vehicle or equipment) may affect the rail car's resonant frequency. For example, a rail car with its load centered has a resonant frequency of a certain value. If the load shifts forward in the rail car, in the direction of travel, the resonant frequency may decrease. If the load is shifted rearward in the rail car, opposite the direction of travel, the resonant frequency may increase. The detection of mass shifting is desirable since it may indicate potential damage to the cargo vessel.

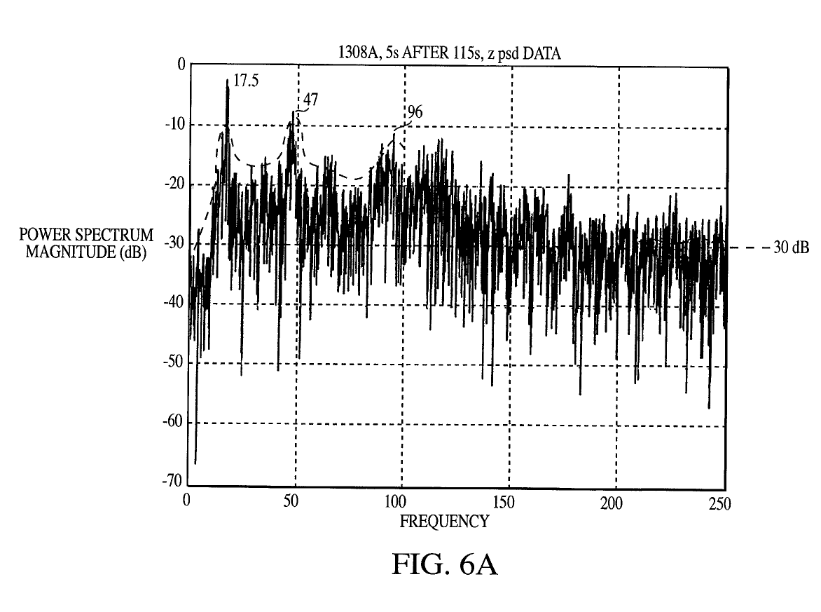

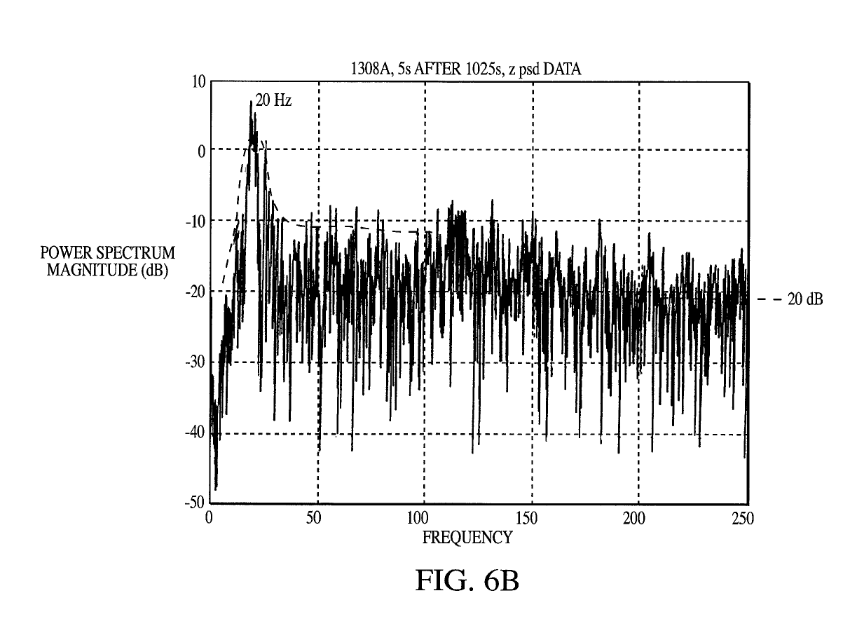

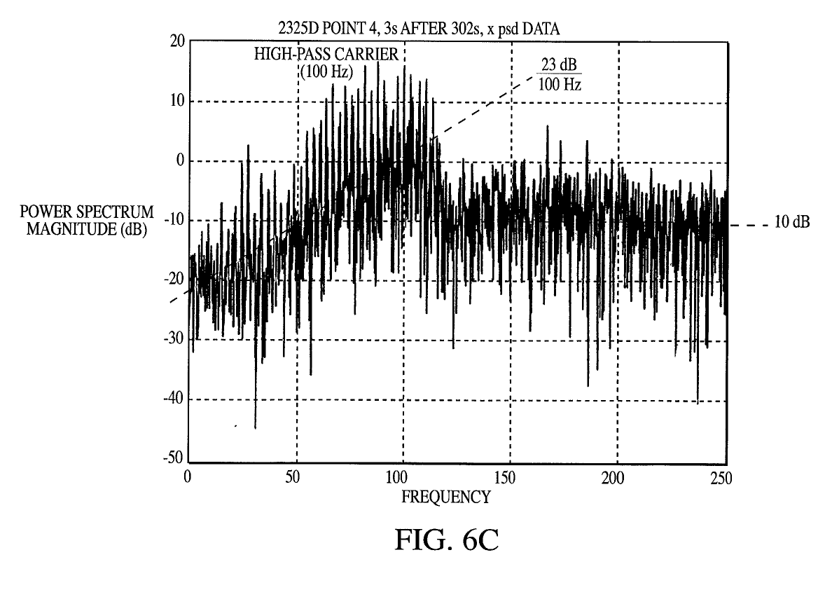

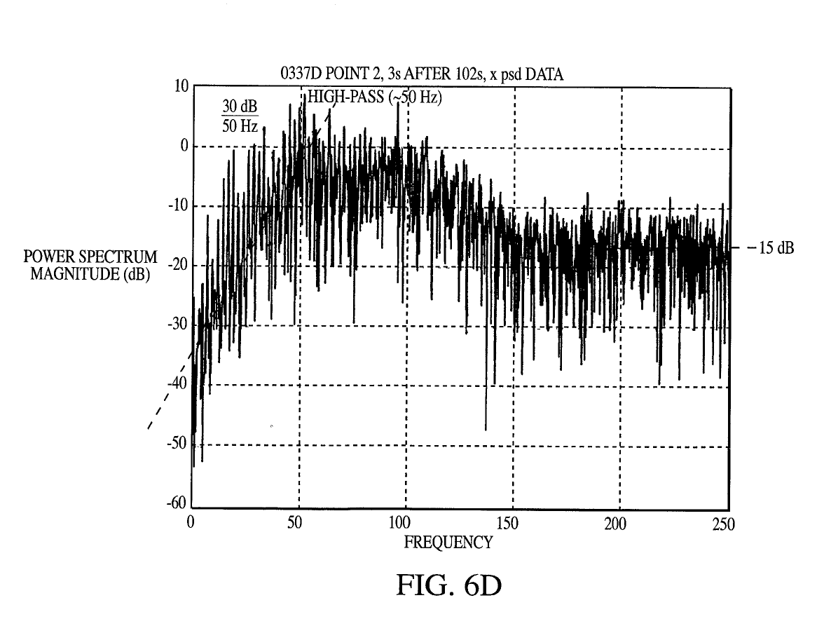

To better illustrate the effect of the load weight condition of a cargo vessel, reference is made to FIGS. 6A-6D. FIGS. 6A and 6B depict the frequency response of a loaded cargo vessel and an unloaded cargo vessel, respectively, for a relatively low-speed condition, such as 3-5 miles per hour. FIGS. 6C and 6D illustrate the frequency response of a loaded cargo vessel and an unloaded cargo vessel, respectively, for a relatively high-speed condition, such as 40-60 miles per hour. At low speeds, resonant frequencies of 17.5, 47, and 96 Hertz (“Hz”) are obtained for the loaded vessel and a resonant frequency of 20 Hz is obtained for the unloaded vessel. Although the high-speed data supports the resonant frequency characteristic observed at lower speed conditions, the resonant frequencies are more difficult to identify than with the low-speed data. From the figures, however, it is clear that the resonant frequency increases in occurrence when the vessel is fully loaded. The speeds chosen to illustrate or determine frequency response characteristics may differ from the examples shown in FIGS. 6A-6D.

Embodiments of the present invention may utilize variations of a signal processing method for assessing and quantifying the load weight status of the cargo vessel. In a preferred embodiment, the method includes application of a 2-D histogram algorithm, a selective threshold detection scheme, and a multi-timeslot voting logic strategy. The method has been implemented for use with an 8 MHz 8-bit microcontroller, but could also be utilized with an 8-bit or 16-bit microcontroller for lower, overall system cost. Although very specific quantities, percentages, counts, and other parameters are specified for the following discussion, the scope of the invention is intended to encompass other quantities, percentages, counts, and other parameters to suit the needs of any particular application. In addition, more or fewer processing steps may be included to provide greater or lesser accuracy or confidence, for example.

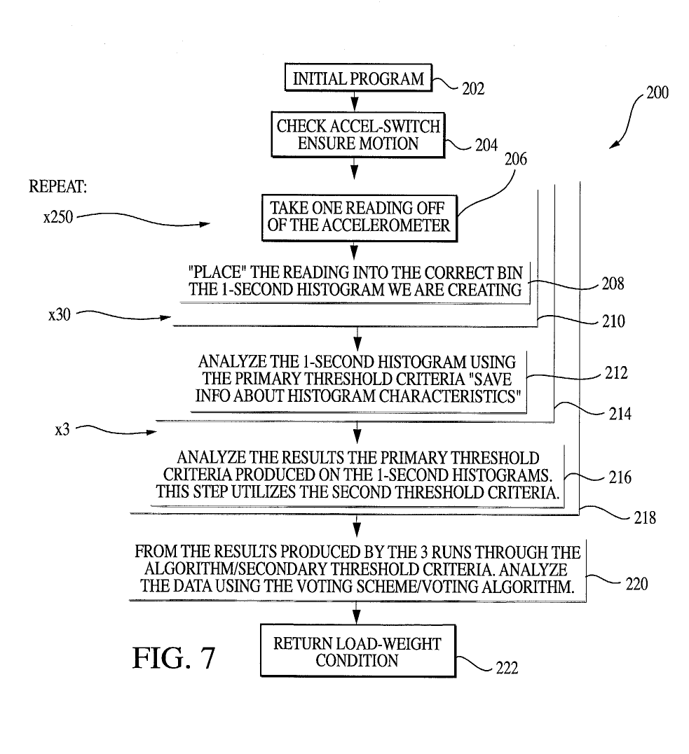

FIG. 7 depicts a flow diagram illustrating a method 200 for determining load weight status, according to a preferred embodiment of the present invention. The method 200 was developed by investigating two-dimensional histograms/contours, identifying sampling frequency requirements, identifying histogram bin requirements, identifying the number of histograms required, determining a threshold detection, and determining a voting structure. These determinations were made based on the particular application for which load weight status was to be developed, and on the level of confidence and accuracy required. An acceleration sensor was utilized in conjunction with a data logger to obtain raw data for a rail car traveling at known approximate speeds under known conditions (i.e. empty or full). The collected data was analyzed on a notebook computer using a signal processing toolbox program for signal analysis. Thresholds were identified to distinguish loaded cars from unloaded cars. This experimental setup provided a basis for the method 200. A similar process may be performed for other types of transport vehicles, to better highlight differences corresponding to different load weight status conditions.

In steps 202 and 204 of the method 200, initial setup operations are performed and a check is made to determine motion (e.g. such as by checking output from the acceleration sensor). In steps 206 through 218, readings are taken from the acceleration sensor every second during three consecutive 30-second time intervals. For each 30-second time interval, 30 one-second 2-D histograms are created using the peak amplitude and the peak width criteria. The histograms are then analyzed using a two-part primary threshold criteria. A “peak amplitude” threshold value is set to perform a histogram calculation along the time base axis in order to calculate the total number of amplitude events that exceed a certain threshold limit for the 1 second time period. A “peak width” threshold value is used to determine the “base width” of the identified amplitude exceedance events. The base width is the actual width at the base of individual peak amplitude events. These two calculations are repeated for each 1-second histogram until a 30-second time limit is reached.

Table 1 illustrates a software implementation (in C++) of a primary threshold structure according to a preferred embodiment.

TABLE 1

%ampct23, ampct25, widthct4 and widthct6
are the primary threshold counters.
%This makes a histogram with 40 bins
histogram = hist(xdata′,40)′;
%This makes a histogram with 40 bins
histogram = hist(xdata′,40)′;
%This finds the maximum peak and places it into a
temp variable hold = max(hold1);
%This loop is used to count the widths of the histograms
at a given amplitude
for w = 1:40,

tempval − histogram(w,1);
if tempval >=4

widthct4 = widthct4 + 1;
if tempval >=6
widthct6 = widthct6 + 1;
end

end

end
%These two if statements check amplitude
if hold >=23

ampct23 = ampct23 + 1;

end
if hold >=25

ampct25 = ampct25 + 1;

end

The data is then analyzed using a secondary threshold criterion to determine two parameters, the load weight status and a level of confidence factor, for the 30-second interval. The load weight status parameter indicates whether the vessel is loaded or unloaded. A confidence factor is a statistical range value with a specified probability that the given parameter, i.e., peak width, of interest lies within the range. The level of confidence factor for the peak amplitude criteria can vary from 30% to 60% to 90%, while the level of confidence factor for the peak width criteria can range from 50-0%. Once these calculations are completed for the first 30-second interval, then the entire method is repeated for two additional consecutive 30-second time intervals, for a total of 90 seconds. The results are then provided to a voting algorithm routine to determine the final output of the sensor system. Table 2 illustrates a software implementation (in C++) of a secondary threshold structure according to a preferred embodiment.

TABLE 2

%This set if/elseif statements checks the amplitude at 23. A 3
represents 99% certainty of loaded conditions, a 2 represents
a 66% certainty of loaded conditions, and a 1 represents 33%
certainty of loaded conditions
if ampct23 >=18

ampvt23(p) = 3;

elseif (ampct23 = = 17 | ampct23 = =16)

ampvt23(p) = 2

elseif (ampct23 = = 14 | ampct23 = = 15)

ampvt23(p) = 1;

else
end
%This set of if/else if statements checks the amplitude at 25. A 3
represents a 99% certainty of unloaded conditions, a 2 represents a
66% certainty of unloaded conditions and a 1 represents a 33%
certainty of unloaded conditions
if ampct25 <= 10

ampvt25(p) = 3;

elseif(ampct25 = = 12 | ampct25 = = 11)

ampvt25(p) = 2;

elseif (ampct25 = = 14 | ampct25 = = 13)

ampvt25(p) = 1;

else
end
%These two sets of if/else statements are used to determine if the
width represents loaded or unloaded conditions. A 1 represents
loaded conditions and a −1 represents unloaded conditions. The
differences between widths in loaded or unloaded cars are small, so
these if only a 1/−1 degree of certainty.
if widthct4 <= 565

widthvt4(p) = 1;

else

widthvt4(p) = −1;

end

if widthct6 <=470

widthvt6(p) = 1;

else

widthvt6(p) = −1;

end

To determine the output state of the system, A voting scheme may be used to examine and correlates the data in a round-robin fashion, as follows. The confidence factor for the peak amplitude of a first and a second dataset are compared with each other. If they both have a 90% confidence factor, then the load weight status is determined by the second threshold criteria and output to the user. If not, then the confidence factor of the first and a third dataset are compared. If they both have a confidence factor of 90%, then the load weight status is determined by the second threshold criteria and output to the user. Table 3 illustrates a MATLAB implementation of a voting scheme, according to a preferred embodiment.

TABLE 3

```
votefinal = 0;
if (ampvt23(1)= =3 & ampvt23(2)= =3)
    votefinal = 3;
elseif (ampvt23(1)= =3 & ampvt23(3)= =3
    votefinal = 3;
elseif (ampvt23(2)= =3 & ampvt23(3)= =3)
    votefinal = 3;
elseif (ampvt25(1)= =3 & ampvt25(2)= =3)
    votefinal = −3;
elseif (ampvt25(1)= =3 & ampvt25(3)= =3)
    votefinal = −3;
elseif (ampvt25(2)= =3 & ampvt25(3)= =3)
    votefinal = −3;
%Section to see if we have 1 90% and 1 60%
%If we have a 60% certainty (2), then we need to check
the widths of that 30-second trial to determine if
%the data really was loaded or unloaded
elseif (ampvt23(1)= =3 & ampvt23(2)= =2)
    if (widthvt4(2)= =1 | widthvt6(2)= =1)
        votefinal = 2;
    end
elseif (ampvt23(1)= =3 & ampvt23(3)= =2)
    if (widthvt4(3)= =1 | widthvt6(3)= =1)
        votefinal = 2;
    end
elseif (ampvt23(2)= =3 & ampvt23(1)= =2)
    if (widthvt4(1)= =1 | widthvt6(1)= =1)
        votefinal = 2;
    end
elseif ampvt23(2)= =3 & ampvt23(3)= =2)
    if (widthvt4(3)= =1 | widthvt6(3)= =1)
        votefinal = 2;
    end
elseif ampvt23(3)= =3 & ampvt23(1)= =2)
    if (widthvt4(1)= =1 | widthvt6(1)= = 1)
        votefinal = 2;
    end
elseif ampvt23(3)= =3 & ampvt23(2)= =2)
    if (widthvt4(2)= =1 | widthvt6(2)= =1)
        votefinal = 2;
    end
elseif ampvt25(1)= =3 & ampvt25(2)= =2)
    if (widthvt4(2)= = −1 | widthvt6(2)= = −1)
        votefinal = −2;
        end
elseif ampvt25(1)= =3 & ampvt25(3)= =2)
    if (widthvt4(3)= = −1 | widthvt6(3)= = −1)
        votefinal = −2;
    end
elseif ampvt25(2)= =3 & ampvt25(1)= =2)
    if (widthvt4(1)= = −1 | widthvt6(1)= = −1)
        votefinal = −2;
    end
elseif ampvt25(2)= =3 & ampvt25(3)= =2)
    if (widthvt4(3)= = −1 | widthvt6(3)= = −1)
        votefinal = −2;
    end
elseif ampvt25(3)= =3 & ampvt25(1)= =2)
    if (widthvt4(1)= = −1 | widthvt6(1)= = −1)
        votefinal = −2;
    end
elseif ampvt25(3)= =3 & ampvt25(2)= =2)
    if(widthvt4(2)= = −1 | widthvt6(2)= = −1)
        votefinal = −2;
    end
%Check to see if we have 2 60% returns. If we do, then we
just check the widths of both time periods to %make sure
they are truly loaded or unloaded
elseif (ampvt23(1)= =2 & ampvt23(2)= =2)
    if (widthvt4(1)= =1 & widthvt4(2)= =1)
        votefinal = 1;
    elseif (widthvt6(1)= =1 & widthvt6(2)= =1)
        votefinal = 1;
    else
    end
elseif (ampvt23(1)= =2 & ampvt23(3)= =2)
    if (widthvt4(1)= =1 & widthvt4(3)= =1)
        votefinal = 1;
    elseif (widthvt6(1)= =1 & widthvt6(3)= =1)
        votefinal = 1;
    else
    end
elseif (ampvt23(2)= =2 & ampvt23(3)= =2)
    if (widthvt4(2)= =1 & widthvt4(3)= =1)
        votefinal = 1;
    elseif (widthvt6(2)= =1 & widthvt6(3)= =1)
        votefinal = 1;
    else
    end
elseif (ampvt25(1)= =2 & ampvt25(2)= =2)
    if(widthvt4(1)= = −1 & widthvt4(2)= = −1)
        votefinal = −1;
    elseif(widthvt6(1)= = −1 & widthvt6(2)= = −1)
        votefinal = −1;
    else
    end
elseif (ampvt25(1)= =2 & ampvt25(3)= =2)
    if(widthvt4(1)= = −1 & widthvt4(3)= = −1)
        votefinal = −1;
    elseif (widthvt6(1)= = −1 & widthvt6(3)= = −1)
        votefinal = −1;
    else
    end
elseif (ampvt25(2)= =2 & ampvt25(3)= =2)
    if(widthvt4(2)= = −1 & widthvt4(3)= = −1)
        votefinal = −1;
    elseif (widthvt6(2)= = −1 & widthvt6(3)= = −1)
        votefinal = −1;
    else
    end
%if no answer found, we never change votefinal, so
the default 0 is returned
else
%End of the voting if/elseif loop
end
```

If the first dataset has a confidence factor for the peak amplitude of 90% and one of the second or third dataset has a confidence factor of 60%, then the peak width criteria confidence factor is checked. If the peak width-based confidence factor is 50%, a load weight status is determined by the second threshold criteria.

If the first dataset has a confidence factor for the peak amplitude of 60% and one of the second or third dataset has a confidence factor of 90%, then the peak width criteria confidence factor is checked. If the peak width-based confidence factor is 50%, a load weight status is determined by the second threshold criteria.

If the first dataset has a confidence factor for the peak amplitude of 30% and one of the second or third dataset has a confidence factor of 60%, then the peak width criteria confidence factor has to be checked. If the peak width-based confidence factor is 50%, a load weight status is determined by the second threshold criteria and output. However, if the voting logic does not find parity between the two datasets (i.e., the confidence factors of the compared datasets are 30%), then a default status condition of full car will be output to the user.

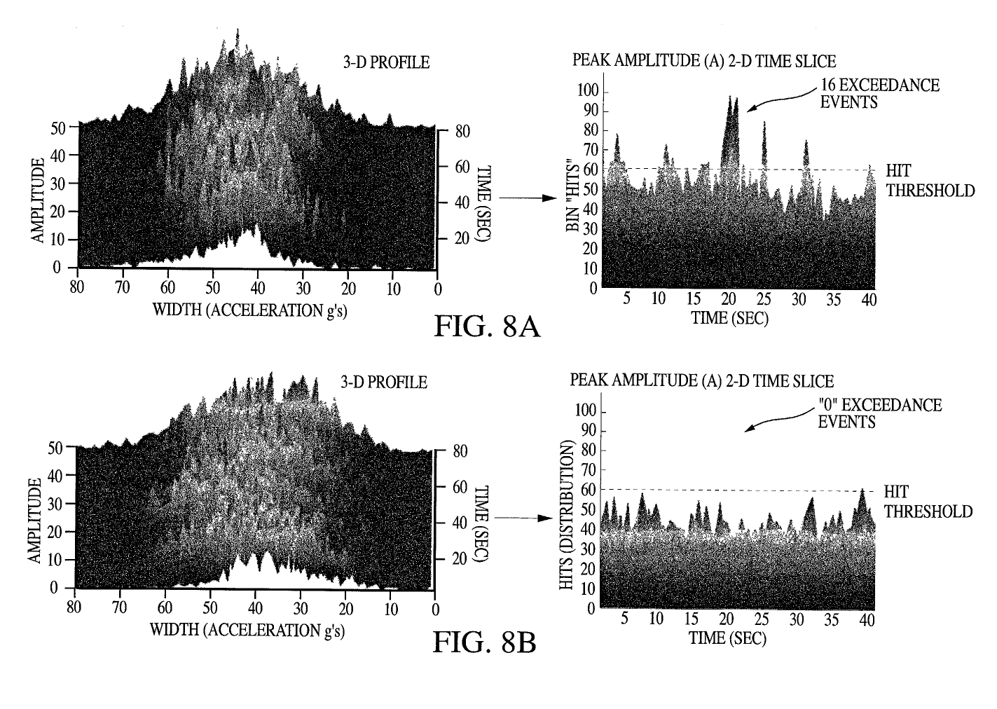

The histograms described with reference to the method 200 shown in FIG. 7 are preferably two-dimensional to enable efficient and economical processing. FIGS. 8A and 8B illustrate three-dimensional and two-dimensional histograms for a loaded coal car and an unloaded coal car, respectively. While it is apparent that differences exist in the 3-D profiles for the loaded car and unloaded car (as evidenced by the number and size of the dark colored peaks near the center of the profiles), processing of such 3-D profiles would be computationally expensive for many applications. Thus, the method 700 utilizes 2-D “time slices” similar to those shown on the right-hand sides of FIGS. 8A and 8B. By choosing an appropriate threshold, such as through the experimental setup described above with reference to FIG. 7, the 2-D histograms provide a clear indication of loaded versus unloaded, by distinguishing the number of “exceedance events” (peak amplitudes) exceeding the predetermined threshold value.

In general, a loaded vehicle will exhibit different histogram characteristics than an unloaded vehicle. For example, a loaded vehicle is likely to have higher peak amplitudes, wider peak events, a lower distribution density, a narrower histogram envelope width, a higher frequency content (e.g. up to 150 Hz. versus less than 100 Hz.), and a slightly lower fundamental frequency (e.g. 17.5 Hz. Versus 20 Hz.) than the same car unloaded. While presently preferred embodiments currently utilize peak amplitude and peak width to determine load weight status, one or more of these other characteristics may alternatively or additionally be used.

The embodiments described herein provide various advantages, such as resistance to dirt, debris, and ice build-up. Alignment, calibration, and repair requirements are also substantially lessened. In addition, other parameters besides load weight, such as damaged wheels and bearings, may also be determined using techniques disclosed herein.

While the invention has been described in connection with certain preferred embodiments, it should be understood that variations may made without departing from the intended scope of the invention. For example, the concepts and embodiments for determining load weight status, as described herein, may be applied to any transportation-related device, mechanism, or vehicle that experiences motion. This includes cargo vessels, rail cars, semi-trailers, marine vessels, and others. Similarly, although preferred embodiments of the invention utilize acceleration measurements in the “z-axis” (orthogonal to the plane in which the vehicle is traveling), alternative embodiments may include one or more other measurement axes.

1. A system for determining load weight status for a vehicle operable to move over a surface, comprising in combination:
an acceleration sensor secured to the vehicle, wherein the acceleration sensor is operable to obtain a vibration input associated with the vehicle; and
a processor operable to determine the load weight status from the vibration input using time domain processing.

2. The system of claim 1, further comprising an output mechanism operable to provide the load weight status to an entity selected from the group consisting of a user and a monitoring system.

3. The system of claim 1, wherein the acceleration sensor is a single-axis accelerometer oriented to measure acceleration in a z-axis, wherein the z-axis is substantially orthogonal to the surface over which the vehicle is operable to move.

4. The system of claim 1, wherein the acceleration sensor is operable to periodically provide the vibration input to the processor as a voltage level per unit time.

5. The system of claim 1, wherein the acceleration sensor is connected to the processor by a link selected from the group consisting of a hard-wired connection and a wireless link.

6. The system of claim 1, wherein the acceleration sensor and the processor are co-located.

7. The system of claim 1, wherein the processor is located remotely from the acceleration sensor.

8. The system of claim 7, wherein the processor is located remotely from the vehicle.

9. The system of claim 1, further comprising a wireless transceiver operable communicate the load weight status wirelessly.

10. The system of claim 1, wherein the load weight status is communicated wirelessly to an entity selected from the group consisting of a handheld terminal, a traffic control tower, and a fleet administration authority.

11. The system of claim 1, wherein the vehicle is a rail car, and wherein the load weight status is communicated via a hard-wired connection to a locomotive connected to the rail car.

12. The system of claim 1, wherein the vehicle is selected from the group consisting of a rail car, a truck, a boat, and a bus.

13. The system of claim 1, wherein the vehicle is a rail car, and wherein at least one of the acceleration sensor and the processor is located within a portion of the rail car to avoid environmental exposure.

14. The system of claim 1, wherein the vehicle is a rail car operable to move on at least one rail, and wherein at least one of the acceleration sensor and the processor is located substantially away from the at least one rail.

15. The system of claim 1, further comprising an analog-to-digital converter connected between the acceleration sensor and the processor.

16. The system of claim 1, wherein the processor includes an associated memory.

17. The system of claim 1, wherein the vehicle is a rail car, wherein at least one of the acceleration sensor and the processor are integrated with a rail car handbrake device, and wherein the rail car handbrake device comprises:
a handbrake controller including the processor; and
a pneumatic brake release mechanism operable to operate a brake for the rail car.

18. A system for determining a load weight status for a rail car comprising, in combination:
an acceleration sensor operable to periodically provide a vibration input associated with movement by the rail car; and
a handbrake controller having a processor and means for operating a brake for the rail car, wherein the processor is operable to receive the vibration input, wherein the processor is operable to determine a vibration signature from the vibration input, and wherein the processor is operable to determine the load weight status by applying a time-domain histogram analysis to the vibration signature.

19. The system of claim 18, wherein the processor is operable to apply a voting scheme to assist in determining the load weight status.

20. A method for determining a load weight status for a vehicle, comprising in combination:
providing a vibration input associated with the vehicle; and
determining the load weight status by applying time-domain processing to the vibration input.

21. The method of claim 20, wherein the vibration input is provided by an acceleration sensor secured to the vehicle, and wherein the load weight status is determined by a processor linked to the acceleration sensor.

22. The method of claim 20, wherein determining the load weight status comprises:
applying a histogram algorithm to the vibration input to obtain at least one histogram;
applying a threshold detection scheme to determine the load weight status and a confidence factor for each of the at least one histogram; and
applying a voting algorithm to the load weight status and the confidence factor to determine a load weight status output.

23. A computer readable medium including instructions for causing a processor to execute the instructions of claim 22.
